(19) United States
(12) Patent Application Publication
(10) Pub. No.: US 2012/0144156 A1
(43) Pub. Date: Jun. 7, 2012

(54) METHOD FOR CONTROLLING INFORMATION PROCESSING APPARATUS AND INFORMATION PROCESSING APPARATUS

(75) Inventor: Takashi MATSUDA, Kawasaki (JP)

(73) Assignee: FUJITSU LIMITED, Kawasaki-shi (JP)

(21) Appl. No.: 13/238,121

(22) Filed: Sep. 21, 2011

(30) Foreign Application Priority Data
Dec. 7, 2010 (JP) 2010-272304

(51) Int. Cl. G06F 15/76; G06F 15/16; G06F 9/02

(52) U.S. Cl. 712/29; 712/E09.002

(57) ABSTRACT

A method for controlling an information processing apparatus including a processor which operates an operating system and a kernel which is operated independently of the operating system, and a network interface through which the information processing apparatus is connectable to an other information processing apparatus, the method includes notifying, by the operating system, the kernel of system down information about the operating system, determining, by the kernel, a kind of an Internet protocol included in a packet received from the other information processing apparatus connected through the network interface, creating, by the kernel, a packet for notifying of the system down in accordance with the determined kind of the Internet protocol, and transmitting, by the kernel, the created packet to the other information processing apparatus via the network interface.

### CROSS-REFERENCE TO RELATED APPLICATION

This application is based upon and claims the benefit of priority of the prior Japanese Patent Application No. 2010-272304 filed on Dec. 7, 2010, the entire contents of which are incorporated herein by reference.

### FIELD

The disclosed technology relates to a method for controlling a method for controlling an information processing apparatus, the information processing apparatus.

### BACKGROUND

In related art, operating systems (OSs) in information processing apparatuses immediately stop the current processing upon detection of occurrences of system down.

When the system down of the OS occurs while such an information processing apparatus establishes data communication with another information processing apparatus, it is not possible for the information processing apparatus to return a response to packet communication from the other information processing apparatus, for example, at predetermined time intervals. Accordingly, a problem occurs in that detection of the system down of the OS is delayed in the other information processing apparatus. The delay in the detection of the system down of the OS delays countermeasures including recovery of the OS of the information processing apparatus and/or change of operation for the information processing apparatus, which are performed by a user of the other information processing apparatus.

Such an information processing apparatus has a kernel installed therein. The kernel manages the data communication with another information processing apparatus and so on. Upon occurrence of the system down of the OS when a monolithic kernel is used as the kernel, the operation of the kernel is stopped in conjunction with the system down of the OS and, thus, it is not possible for the information processing apparatus to access a network. Accordingly, it is not possible for the information processing apparatus to provide a function of voluntarily transmitting system down information about the own OS to the other information processing apparatus upon occurrence of the system down of the OS. Consequently, the other information processing apparatus can detect the occurrence of the system down in the OS only after it detects that no response of the packet communication is returned from the information processing apparatus, as described above.

In recent years, a microkernel capable of operating independently of the operation of the OS is adopted as the kernel. The microkernel is capable of continuing the operation without stop even if the system down occurs in the OS in the information processing apparatus. In other words, the microkernel continues to return a response to the packet communication from the other information processing apparatus regardless of an occurrence of the system down of the OS.

Accordingly, it is not possible for the other information processing apparatus to adopt the method of detecting the system down of the OS by detecting that no response to the packet communication is returned from the information processing apparatus and to recognize the occurrence of the system down in the OS in the information processing apparatus.

A technology to maintain an information processing apparatus by displaying the system down information about the OS in a remote console by a system manager and a maintenance man is known. Specifically, a control driver is used to compress display data for the system down information output from the OS upon occurrence of the system down of the OS and the compressed display data is transmitted to a dedicated remoter apparatus. The remote apparatus decompresses the received display data and displays the system down information on the remote console.

For example, refer to Japanese Laid-open Patent Publication No. 2004-30337.

However, the information processing apparatus is required to prepare a dedicated control driver and perform version-up of the OS in order to transmit the system down information generated by the OS to the remote apparatus. In addition, since the method of using the remote apparatus involves the preparation cost of the remote apparatus, it is difficult to easily use the method in the low-cost information processing apparatuses in recent years.

Furthermore, in order for anther information processing apparatus, instead of the remote apparatus, to independently receive the system down information, the other information processing apparatus is required to prepare a dedicated reception apparatus and perform version-up of the OS. Accordingly, it is not possible to transmit and receive the system down information by using an existing information processing apparatus and another information processing apparatus.

### SUMMARY

According to an aspect of an embodiment, a method for controlling an information processing apparatus including a processor which operates an operating system and a kernel which is operated independently of the operating system, and a network interface through which the information processing apparatus is connectable to an other information processing apparatus, the method includes notifying, by the operating system, the kernel of system down information about the operating system, determining, by the kernel, a kind of an Internet protocol included in a packet received from the other information processing apparatus connected through the network interface, creating, by the kernel, a packet for notifying of the system down in accordance with the determined kind of the Internet protocol, and transmitting, by the kernel, the created packet to the other information processing apparatus via the network interface.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of the configuration of an information processing apparatus according to an embodiment;

FIG. 2 is a block diagram illustrating an example of the functional configuration of the information processing apparatus according to the present embodiment;

FIG. 3 is a sequence chart illustrating an exemplary operation of the information processing apparatus according to the present embodiment;

FIG. 4 illustrates the position of a socket processing part in a layered structure of a protocol installed in a kernel in the information processing apparatus according to the present embodiment;

FIG. 5 illustrates an example of the configuration of the socket processing part installed in the information processing apparatus according to the present embodiment and socket management information;

FIG. 6 is a flowchart illustrating an exemplary operation of the information processing apparatus according to the present embodiment;

FIG. 7 is a flowchart illustrating an exemplary operation of the information processing apparatus according to the present embodiment;

FIG. 8 is a flowchart illustrating an exemplary operation of the information processing apparatus according to the present embodiment;

FIG. 9 is a flowchart illustrating an exemplary operation of the information processing apparatus according to the present embodiment; and

FIG. 10 is a flowchart illustrating an exemplary operation of the information processing apparatus according to the present embodiment.

### DESCRIPTION OF EMBODIMENTS

Embodiments of a method of controlling an information processing apparatus and the information processing apparatus will herein be described with reference to the attached drawings. However, the invention is not limited to the embodiments.

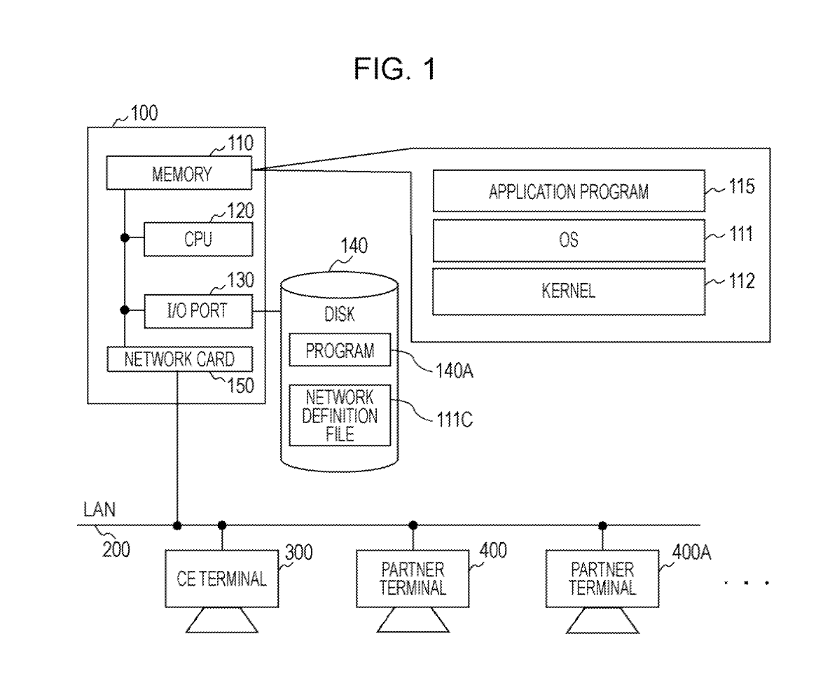

FIG. 1 is a block diagram illustrating an example of the configuration of an information processing apparatus 100 according to an embodiment. The information processing apparatus 100 includes a memory 110, a central processing unit (CPU) 120, an input-output (I/O) port 130, a disk 140, and a network card 150.

The memory 110 includes an operating system (OS) 111, a kernel 112, and an application program 115. The kernel 112 is a core part of the OS 111 designed so as to have a layered structure. The kernel 112 manages the resources of the OS 111 and controls transmission and reception of data between hardware and software of the information processing apparatus 100. The application program 115 includes various application programs of the information processing apparatus 100.

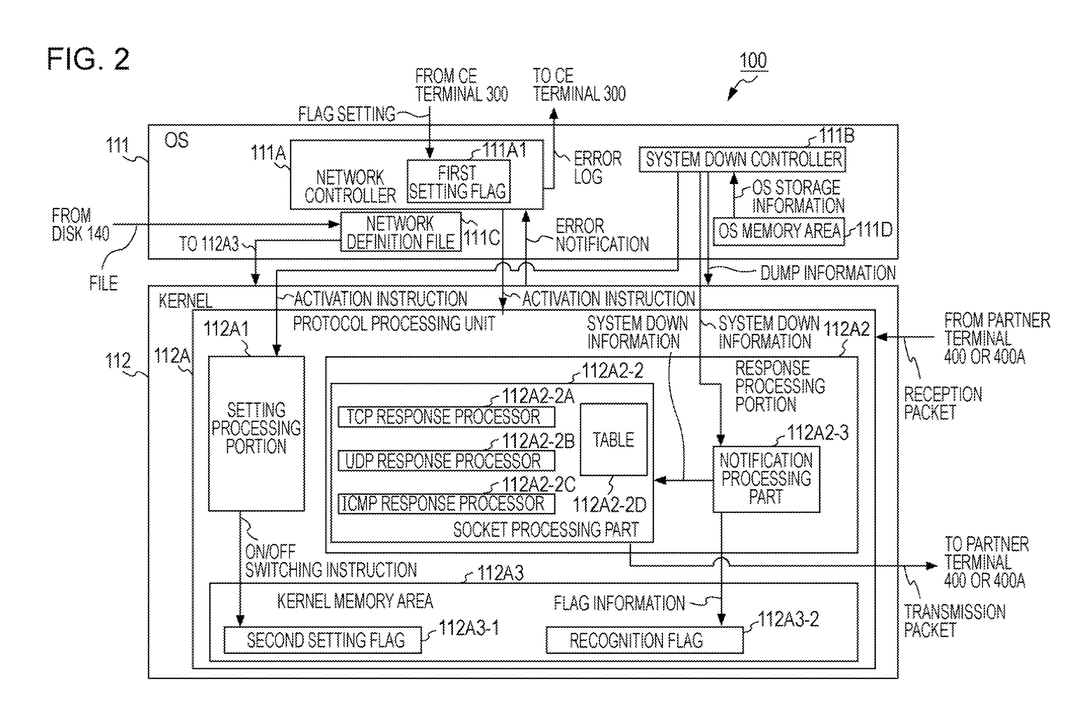

Upon occurrence of system down of the OS 111, the control of the OS 111 is stopped. Even if the control of the OS 111 is stopped, the kernel 112, the CPU 120, the I/O port 130, the disk 140, and the network card 150 in the information processing apparatus 100 operate independently of the OS 111. A microkernel is used as the kernel 112. The use of the microkernel causes the OS 111 to operate independently of the kernel 112 in the information processing apparatus 100. The use of the microkernel as the kernel 112 allows the kernel 112 to independently operate even if the system down occurs in the OS in the information processing apparatus 100. Accordingly, a protocol processing unit 112A and a kernel memory area 112A3, among functional blocks illustrated in FIG. 2, are capable of operating independently of the OS 111. Since the kernel 112 operates independently of the OS 111, the kernel 112 is capable of operating even if the control of the OS 111 is stopped. The system down of the information processing apparatus 100 according to the present embodiment includes shutdown of the information processing apparatus 100.

The CPU 120 executes a variety of processing in the information processing apparatus 100.

The I/O port 130 provides the function of an interface through which data is transmitted and received between the CPU 120 and the disk 140.

The disk 140 temporarily stores at least part of the programs in the OS 111 executed by the CPU 120, the application program 115, a program 140A controlling the information processing apparatus 100, and a network definition file 111C. In addition, the disk 140 stores a variety of data necessary for the processing in the CPU 120. The network definition file 111C will be described below with reference to FIG. 2.

The program 140A may be held in a storage medium other than the disk 140. For example, the program 140A may be stored in a “portable physical storage medium” such as a flexible disk (FD), a compact disc-read only memory (CD-ROM), a magneto-optical (MO) disk, a digital versatile disk (DVD) disk, or an integrated circuit (IC) card, loaded into the information processing apparatus 100. The program 140A may be stored in a disk unit in or outside the information processing apparatus 100, or a storage medium (not shown) held by “another computer (or server)” connected to the information processing apparatus 100 over, for example, a local area network (LAN), a network, a public line, the Internet, or a wide area network (WAN). The CPU 120 reads out the program 140A from the disk 140 to execute the program 140A.

The network card 150 provides an interface function concerning connection with a LAN 200. The information processing apparatus 100 is connected to a customer engineer (CE) (system manager) terminal 300, a partner terminal 400, and a partner terminal 400A over the LAN 200.

The CE terminal 300 is used by the CE, who is a user of the information processing apparatus 100, to transmit and receive data over the LAN 200.

The partner terminal 400 and the partner terminal 400A transmit and receive data to and from the information processing apparatus 100 over the LAN 200. Specifically, the partner terminal 400 and the partner terminal 400A transmit and receive data to and from the information processing apparatus 100 by using any of multiple Internet protocols including Transmission Control Protocol/Internet Protocol (TCP/IP), User Datagram Protocol/IP (UDP/IP), and Internet Control Message Protocol (ICMP). As illustrated in FIG. 1, the information processing apparatus 100 is connected to multiple terminals including the partner terminal 400 and the partner terminal 400A.

FIG. 2 is a block diagram illustrating an example of the functional configuration of the information processing apparatus 100 according to the present embodiment. The same reference numerals are used in FIG. 2 to identify the same components in FIG. 1. A description of such components is omitted herein.

Referring to FIG. 2, the OS 111 includes a network controller 111A, a system down controller 111B, the network definition file 111C, and an OS memory area 111D.

The network controller 111A includes a first setting flag 111A1. The network controller 111A performs transmission and reception of data between the kernel 112 and the OS 111. The network controller 111A transmits information in the network definition file 111C to the kernel 112. The network controller 111A executes a process of activating or stopping the protocol processing unit 112A in the kernel 112. The network controller 111A transmits an error log to the CE terminal 300 upon notification of an error from the kernel 112.

Upon occurrence of the system down of the OS 111, the first setting flag 111A1 is set to ON in response to an instruction from the CE with the CE terminal 300 in order to enable a network error notification function of the network definition file 111C. Since the setting of the first setting flag 111A1 is switched in response to an instruction from the CE terminal 300, the CE is capable of switching between transmission and no-transmission of system down information to each of the partner terminal 400 and the partner terminal 400A.

Upon occurrence of the system down in the OS 111, the system down controller 111B supplies memory dump information to the kernel 112, as a memory dump process, before the OS 111 is stopped. The memory dump process is, for example, a process of storing (dumping) the content of data stored in the memory 110 at abnormal termination of the OS 111 in the kernel memory area 112A3, which is a non-volatile area of the kernel 112. The memory dump information is the content of data that is dumped in the memory dump process. The memory dump information is used, for example, to analyze the problem of the used program 140A in diagnosis of the cause of the system down. The system down controller 111B instructs a setting processing portion 112A1 to start the kernel 112 upon occurrence of the system down in the OS 111.

The network definition file 111C is a file defining information about the information processing apparatus 100, the CE terminal 300, the partner terminal 400, and the partner terminal 400A. The network definition file 111C includes, for example, the data communication speed set by the network card 150 illustrated in FIG. 1 and information about an IP address and a gateway address of each of the information processing apparatus 100, the CE terminal 300, the partner terminal 400, and the partner terminal 400A. The network definition file 111C is used when the information processing apparatus 100 is connected to the CE terminal 300, the partner terminal 400, and the partner terminal 400A via the network card 150 over the LAN 200 to transmit and receive data. The OS 111 acquires the network definition file 111C from the disk 140.

The OS memory area 111D temporarily stores the data about the OS 111. Upon occurrence of the system down of the OS 111, the system down controller 111B acquires the data about the OS 111 stored in the OS memory area 111D to generate the memory dump information.

Data used when the program 140A operates, and the program 140A is stored in the OS memory area 111D. Upon occurrence of the system down of the OS 111, a system down file for the disk 140 is stored in the OS memory area 111D. The system down file stored in the OS memory area 111D is deleted when the OS 111 is restarted.

The kernel 112 includes the protocol processing unit 112A. The protocol processing unit 112A determines the kind of a protocol included in a reception packet received from the partner terminal 400 or the partner terminal 400A. The protocol processing unit 112A creates a transmission packet including the system down information on the basis of the determined kind of the Internet protocol: TCP/IP, UDP/IP, or ICMP. The protocol processing unit 112A transmits the created transmission packet to the partner terminal 400 or the partner terminal 400A.

The protocol processing unit 112A includes the setting processing portion 112A1, a response processing portion 112A2, and the kernel memory area 112A3.

The setting processing portion 112A1 sets the error notification function to ON or OFF for a second setting flag 112A3-1 in the kernel memory area 112A3. The setting processing portion 112A1 is capable of ensuring a function of returning a packet response to each of the partner terminal 400 and the partner terminal 400A in response to a request from the CE with the CE terminal 300 even during the system down of the OS 111. The setting processing portion 112A1 sets the error notification function to ON to transmit the system down information about the information processing apparatus 100 to each of the partner terminal 400 and the partner terminal 400A.

The response processing portion 112A2 includes a socket processing part 112A2-2 and a notification processing part 112A2-3. The response processing portion 112A2 processes the system down information about the OS 111 notified from the system down controller 111B to create a transmission packet by using any of the Internet protocols: TCP/IP, UDP/IP, and ICMP. The response processing portion 112A2 transmits the created transmission packet to the partner terminal 400 or the partner terminal 400A via the network card 150 over the LAN 200.

The socket processing part 112A2-2 includes a TCP response processor 112A2-2A, an UDP response processor 112A2-2B, an ICMP response processor 112A2-2C, and a table 112A2-2D. The socket means a network address in which the IP address in the network of the information processing apparatus 100 performing the TCP/IP communication, the UDP/IP communication, or the ICMP communication is combined with a port number, which is a sub-address of the IP address. The socket processing part 112A2-2 creates a transmission packet including the system down information about the OS 111 and creates socket information for the response to the partner terminal 400 or the partner terminal 400A. The socket information is created at start of the response to the partner terminal 400 or the partner terminal 400A and is deleted upon termination of the response.

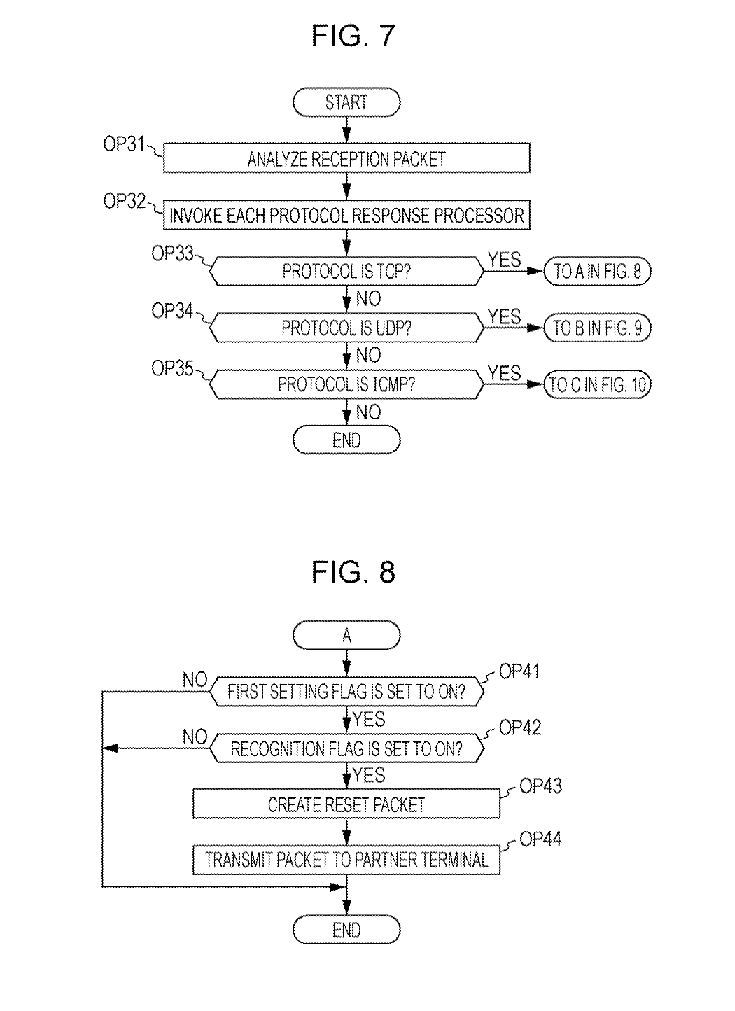

The TCP response processor 112A2-2A creates a transmission packet including the system down information about the OS 111 by using TCP/IP in accordance with processes in FIGS. 7 and 8 described below when the reception packet received from the partner terminal 400 or the partner terminal 400A is created by using TCP/IP. The TCP response processor 112A2-2A transmits the created transmission packet to the partner terminal 400 or the partner terminal 400A via the network card 150 over the LAN 200.

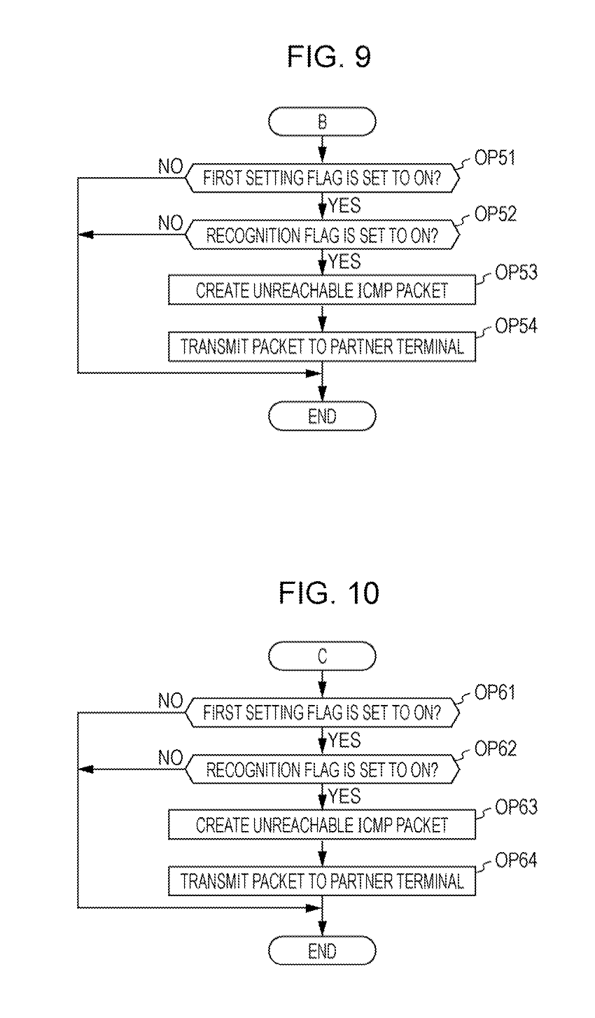

The UDP response processor 112A2-2B creates a transmission packet including the system down information about the OS 111 by using UDP/IP in accordance with processes in FIGS. 7 and 9 described below when the reception packet received from the partner terminal 400 or the partner terminal 400A is created by using UDP/IP. The UDP response processor 112A2-2B transmits the created transmission packet to the partner terminal 400 or the partner terminal 400A via the network card 150 over the LAN 200.

The ICMP response processor 112A2-2C creates a transmission packet including the system down information about the OS 111 by using ICMP in accordance with processes in FIGS. 7 and 10 described below when the reception packet received from the partner terminal 400 or the partner terminal 400A is created by using ICMP. The ICMP response processor 112A2-2C transmits the created transmission packet to the partner terminal 400 or the partner terminal 400A via the network card 150 over the LAN 200. The table 112A2-2D will be described below with reference to FIG. 5.

The notification processing part 112A2-3 processes the system down information supplied from the system down controller 111B. The notification processing part 112A2-3 notifies the socket processing part 112A2-2 of the notified system down information. The notification processing part 112A2-3 notifies a recognition flag 112A3-2 in the kernel memory area 112A3 of flag information indicating that the system down information is notified from the OS 111.

The kernel memory area 112A3 includes the second setting flag 112A3-1 and the recognition flag 112A3-2. The kernel memory area 112A3 temporarily stores the data about the kernel 112. The kernel memory area 112A3 stores the network definition file 111C. The kernel memory area 112A3 stores the memory dump information supplied from the OS 111.

The second setting flag 112A3-1 is switched between ON and OF on the basis of an ON/OFF switching instruction about the first setting flag 111A1 notified from the setting processing portion 112A1. If the first setting flag 111A1 is set to ON, the setting processing portion 112A1 sets the second setting flag 112A3-1 to ON. As described below with reference to FIGS. 8 to 10, when the second setting flag 112A3-1 is set to ON, upon reception of packet information from the partner terminal 400 or the partner terminal 400A after the system down of the OS 111 occurs, the response processing portion 112A2 is capable of transmitting the system down information to the partner terminal 400 or the partner terminal 400A by using the socket processing part 112A2-2.

The recognition flag 112A3-2 is switched between ON and OFF on the basis of the system down information about the OS 111 notified from the notification processing part 112A2-3. The recognition flag 112A3-2 is set to ON when the system down information about the OS 111 is notified from the notification processing part 112A2-3. As described below with reference to FIGS. 8 to 10, when the recognition flag 112A3-2 is set to ON, upon reception of the packet information from the partner terminal 400 or the partner terminal 400A after the system down of the OS 111 occurs, the response processing portion 112A2 is capable of transmitting the system down information to the partner terminal 400 or the partner terminal 400A by using the socket processing part 112A2-2.

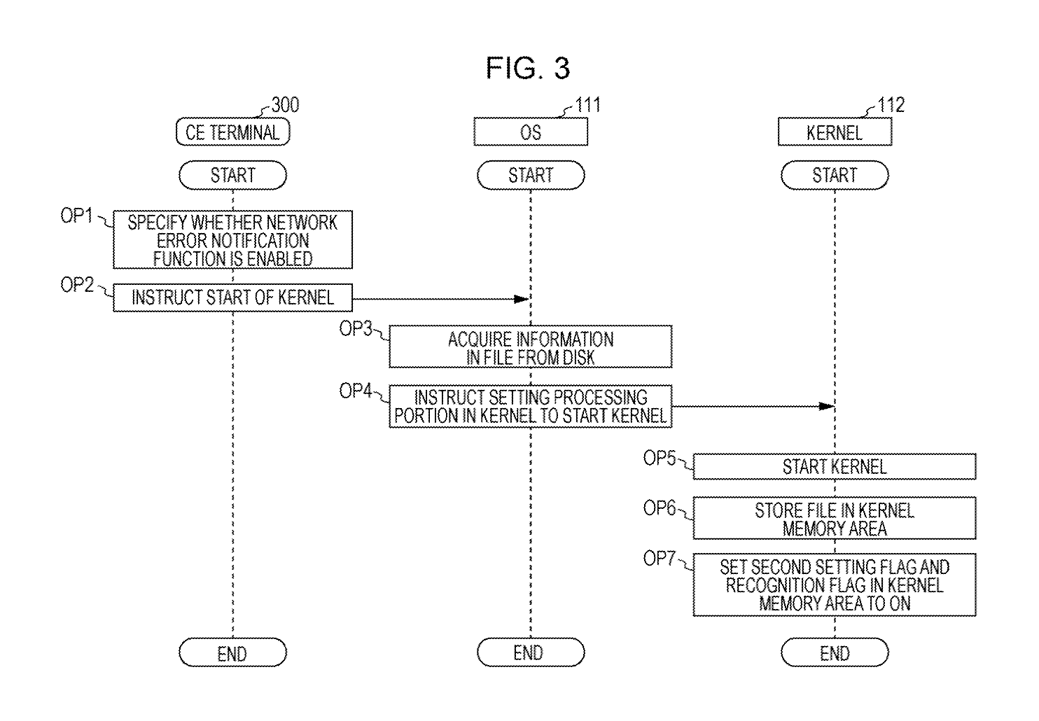

FIG. 3 is a sequence chart illustrating an exemplary operation of the information processing apparatus 100 according to the present embodiment. The process illustrated in FIG. 3 indicates an environment setting process of transmitting the system down information about the OS 111 to the partner terminal 400 or the partner terminal 400A by the CE with the CE terminal 300. For example, the CE issues various instructions with the CE terminal 300 in accordance with the process illustrated in FIG. 3. The same reference numerals are used in FIG. 3 to identify the same components in FIGS. 1 and 2. A description of such components is omitted herein.

Referring to FIG. 3, in OP1, the CE specifies whether the network error notification function is enabled in the network definition file 111C with the CE terminal 300. If the network error notification function is enabled, the CE sets the first setting flag 111A1 in the network controller 111A to ON with the CE terminal 300. In OP2, the CE instructs start of the kernel 112 with the CE terminal 300.

In OP3, upon notification of the instruction to start the kernel 112 from the CE terminal 300, the OS 111 acquires information in the network definition file 111C from the disk 140. In OP4, the system down controller 111B in the OS 111 instructs the setting processing portion 112A1 in the kernel 112 to start the kernel 112.

In OP5, upon notification of the instruction to start of the kernel 112 from the system down controller 111B, the setting processing portion 112A1 in the kernel 112 starts the kernel 112. In OP6, the setting processing portion 112A1 stores the network definition file 111C transmitted from the OS 111 in the kernel memory area 112A3. In OP7, the setting processing portion 112A1 sets the second setting flag 112A3-1 in the kernel memory area 112A3 to ON. In OP7, the notification processing part 112A2-3 sets the recognition flag 112A3-2 in the kernel memory area 112A3 to ON upon occurrence of the system down of the OS 111.

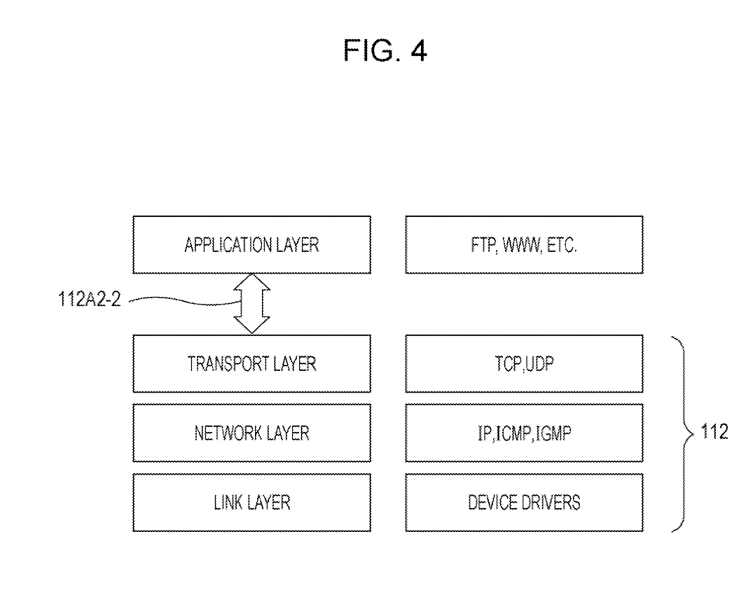

FIG. 4 illustrates the position of the socket processing part 112A2-2 in the layered structure of the protocol installed in the kernel 112 in the information processing apparatus 100 according to the present embodiment. The same reference numerals are used in FIG. 4 to identify the same components in FIGS. 1 to 3. A description of such components is omitted herein.

Referring to FIG. 4, the protocol installed in the information processing apparatus 100 includes an application layer, a transport layer, a network layer, and a link layer. The application layer includes, for example, a File Transfer Protocol (FTP) server and a World Wide Web (WWW) server. The transport layer includes, for example, TCP and UDP. The network layer includes, for example, IP, ICMP, and Internet Group Message Protocol (IGMP). The link layer includes various device drivers. The socket processing part 112A2-2 is provided between the application layer and the transport layer and provides a common socket interface function.

FIG. 5 illustrates an example of the configuration of the socket processing part 112A2-2 installed in the information processing apparatus 100 according to the present embodiment and socket management information. The same reference numerals are used in FIG. 5 to identify the same components in FIGS. 1 to 4. A description of such components is omitted herein.

Referring to FIG. 5, the socket processing part 112A2-2 stores the socket information that is generated in association with each socket number to be stored in the table 112A2-2D at a time when the reception of a packet from the partner terminal 400 or the partner terminal 400A is started. The socket processing part 112A2-2 deletes the generated socket information from the table 112A2-2D to update the table 112A2-2D at a time when the reception of the packet from the partner terminal 400 or the partner terminal 400A is terminated. The socket processing part 112A2-2 creates the socket number associated with the socket information for each of the partner terminal 400 and the partner terminal 400A and stores the created socket number in the table 112A2-2D.

The socket management information including the socket type of the reception packet from each of the partner terminal 400A and the partner terminal 400A is stored in the table 112A2-2D in association with each socket number. The socket processing part 112A2-2 determines whether the reception packet is created by using TCP/IP or UDP/IP with reference to the socket type in the socket management information about the partner terminal 400 or the partner terminal 400A stored in the table 112A2-2D. For example, if the socket type in socket management information 410A associated with the partner terminal 400 is a stream, the socket processing part 112A2-2 determines that the reception packet is created by using TCP/IP. If the socket type in socket management information 410B associated with the partner terminal 400 is a datagram, the socket processing part 112A2-2 determines that the reception packet is created by using UDP/IP. If the socket type in socket management information 410C associated with the partner terminal 400A is a stream, the socket processing part 112A2-2 determines that the reception packet is created by using TCP/IP.

The socket processing part 112A2-2 sequentially refers to the socket numbers from top to bottom of the table 112A2-2D: from a socket number 1 to a socket number N in the socket numbers stored in the table 112A2-2D. The socket number N is the final socket number, among the socket numbers stored in the table 112A2-2D. If a missing number occurs because communication between the information processing apparatus 100 and a partner terminal (not shown) is terminated, the socket processing part 112A2-2 sequentially refers to the socket numbers following the missing number, among the socket numbers stored in the table 112A2-2D. The socket processing part 112A2-2 terminates the process of referring to the table 112A2-2D when the reference to the socket number N is finished.

The socket processing part 112A2-2 is capable of using the TCP response processor 112A2-2A, the UDP response processor 112A2-2B, and the ICMP response processor 112A2-2C and referring to the table 112A2-2D to create the system down information in accordance with the kind of the Internet protocol of the reception packet received from the partner terminal 400 or the partner terminal 400A. Accordingly, the partner terminal 400 and the partner terminal 400A, which are other information processing apparatuses, are capable of receiving the system down information about the OS 111 in the information processing apparatus 100 without adding dedicated hardware and performing version-up of the OS 111.

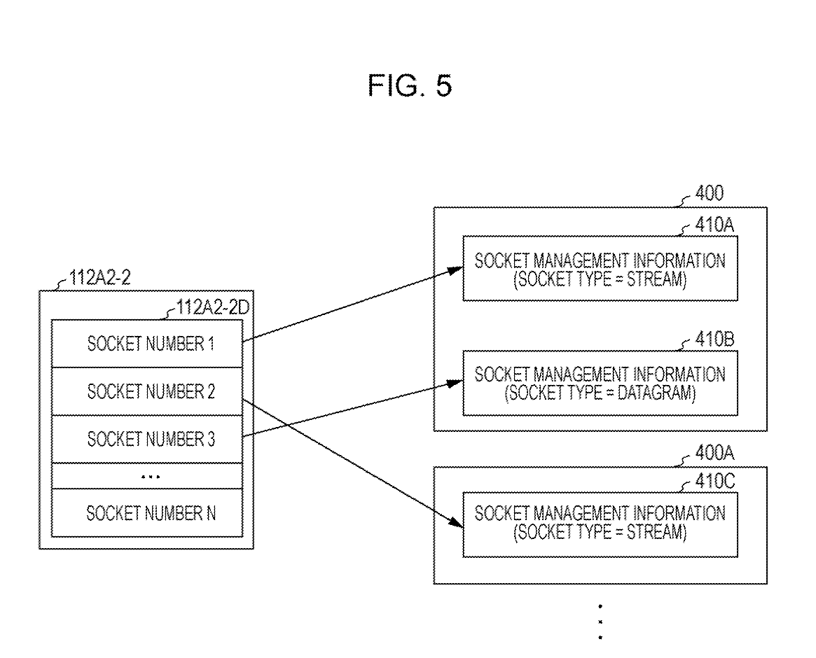

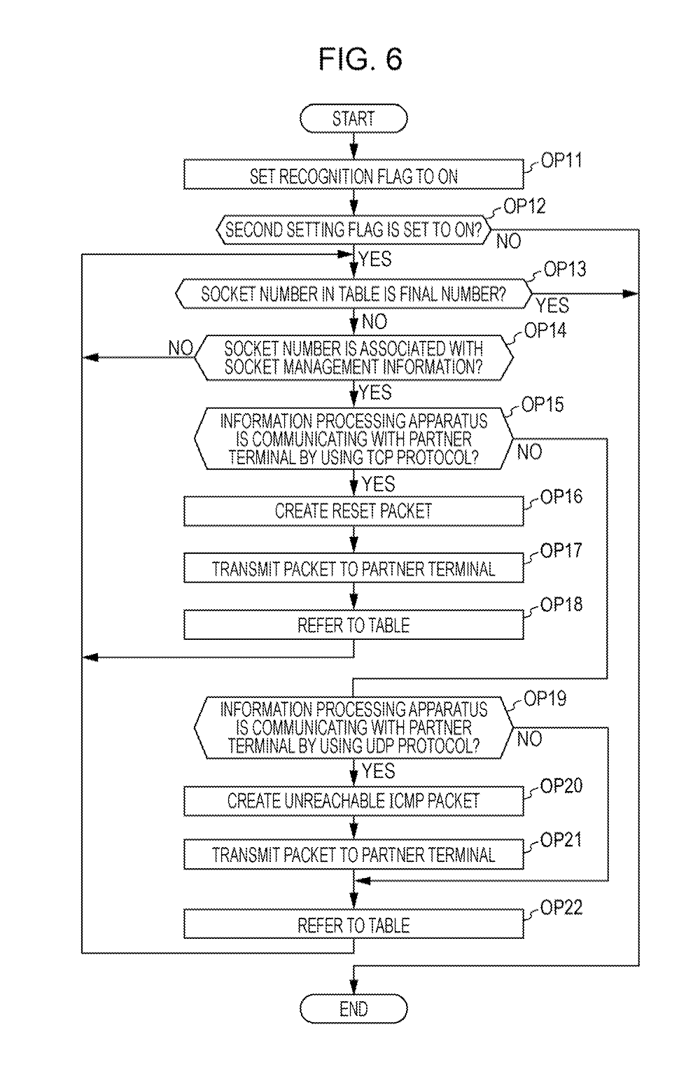

FIG. 6 is a flowchart illustrating an exemplary operation of the information processing apparatus 100 according to the present embodiment. A communication process with the partner terminal 400 or the partner terminal 400A upon occurrence of the system down of the OS 111 is illustrated in FIG. 6. The process in FIG. 6 is performed when the system down information about the OS 111 is transmitted to the kernel 112. The same reference numerals are used in FIG. 6 to identify the same components in FIGS. 1 to 5. A description of such components is omitted herein.

Referring to FIG. 6, upon occurrence of the system down of the OS 111, in OP11, the notification processing part 112A2-3 sets the recognition flag 112A3-2 in the kernel memory area 112A3 to ON. In OP12, the response processing portion 112A2 determines whether the second setting flag 112A3-1 is set to ON. If the second setting flag 112A3-1 is set to ON (YES in OP12), in OP13, the socket processing part 112A2-2 refers to the table 112A2-2D to determine whether the socket number that is referred to is the final socket number. If the second setting flag 112A3-1 is not set to ON (NO in OP12), the information processing apparatus 100 terminates the communication process with the partner terminal 400 or the partner terminal 400A.

If the socket number is not the final socket number (NO in OP13), in OP14, the socket processing part 112A2-2 refers to the table 112A2-2D to determine whether the socket number that is referred to is associated with the socket management information. If the socket number is the final socket number (YES in OP13), the information processing apparatus 100 terminates the communication process with the partner terminal 400 or the partner terminal 400A. If the socket number that is referred to is associated with the socket management information (YES in OP14), in OP15, the socket processing part 112A2-2 refers to the table 112A2-2D to determine whether the information processing apparatus 100 is communicating with the partner terminal 400 or the partner terminal 400A by using TCP. If the socket number that is referred to is not associated with the socket management information (NO in OP14), the process goes back to OP13.

If the information processing apparatus 100 is communicating with the partner terminal 400 or the partner terminal 400A by using TCP (YES in OP15), in OP16, the TCP response processor 112A2-2A creates a RESET packet. The RESET packet is used to request the partner terminal 400 or the partner terminal 400A to reset the communication. If the information processing apparatus 100 is not communicating with the partner terminal 400 or the partner terminal 400A by using TCP (NO in OP15), in OP19, the socket processing part 112A2-2 refers to the table 112A2-2D to determine whether the information processing apparatus 100 is communicating with the partner terminal 400 or the partner terminal 400A by using UDP.

After creating the RESET packet in OP16, in OP17, the TCP response processor 112A2-2A transmits the RESET packet to the partner terminal 400. In OP18, the socket processing part 112A2-2 refers to the table 112A2-2D. Then, the process goes back to OP13.

If the information processing apparatus 100 is communicating with the partner terminal 400 or the partner terminal 400A by using UDP (YES in OP19), in OP20, the UDP response processor 112A2-2B creates an unreachable ICMP packet. The unreachable ICMP packet indicates a state in which the packet transmitted from the partner terminal 400 or the partner terminal 400A does not reach the information processing apparatus 100. If the information processing apparatus 100 is not communicating with the partner terminal 400 or the partner terminal 400A by using UDP (NO in OP19), in OP22, the socket processing part 112A2-2 refers to the table 112A2-2D. Then, the process goes back to OP13.

After creating the unreachable ICMP packet in OP20, in OP21, the UDP response processor 112A2-2B transmits the unreachable ICMP packet to the partner terminal 400 or the partner terminal 400A. In OP22, the socket processing part 112A2-2 refers to the table 112A2-2D. Then, the process goes back to OP13.

The RESET packet and the unreachable ICMP packet are common packets. Accordingly, the socket processing part 112A2-2 is capable of transmitting the system down information by using the common packet in accordance with the kind of the Internet protocol. Consequently, the reception of the common packet allows the partner terminal 400 or the partner terminal 400A, which is another information processing apparatus, to recognize the system down of the information processing apparatus 100 without adding dedicated hardware and performing version-up of the OS 111.

FIGS. 7 to 10 are flowcharts illustrating exemplary operations of the information processing apparatus 100 according to the present embodiment. In particular, FIGS. 8 to 10 illustrate processes performed when a packet is received from the partner terminal 400 or the partner terminal 400A after the system down of the OS 111 occurs. The process indicated by A in FIG. 7 continues into A in FIG. 8. The process indicated by B in FIG. 7 continues into B in FIG. 9. The process indicated by C in FIG. 7 continues into C in FIG. 10. The same reference numerals are used in FIGS. 7 to 10 to identify the same components in FIGS. 1 to 6. A description of such components is omitted herein.

Referring to FIG. 7, upon occurrence of the system down of the OS 111, in OP31, the socket processing part 112A2-2 analyzes the reception packet from the partner terminal 400 or the partner terminal 400A. In OP32, the socket processing part 112A2-2 invokes the TCP response processor 112A2-2A, the UDP response processor 112A2-2B, or the ICMP response processor 112A2-2C on the basis of the result of the analysis of the reception packet. In OP33, the socket processing part 112A2-2 determines whether the protocol of the reception packet from the partner terminal 400 or the partner terminal 400A is TCP.

If the protocol of the reception packet is TCP (YES in OP33), the process goes to A in FIG. 8. If the protocol of the reception packet is not TCP (NO in OP33), in OP34, the socket processing part 112A2-2 determines whether the protocol of the reception packet from the partner terminal 400 or the partner terminal 400A is UDP.

If the protocol of the reception packet is UDP (YES in OP34), the process goes to B in FIG. 9. If the protocol of the reception packet is not UDP (NO in OP34), in OP35, the socket processing part 112A2-2 determines whether the protocol of the reception packet from the partner terminal 400 or the partner terminal 400A is ICMP.

If the protocol of the reception packet is ICMP (YES in OP35), the process goes to C in FIG. 10. If the protocol of the reception packet is not ICMP (NO in OP35), the information processing apparatus 100 terminates the communication process with the partner terminal 400 or the partner terminal 400A. The operation in FIG. 7 is also performed in a normal state in which the system down of the OS 111 does not occur.

Referring to FIG. 8, in OP41, the socket processing part 112A2-2 determines whether the first setting flag 111A1 is set to ON. If the first setting flag 111A1 is set to ON (YES in OP41), in OP42, the socket processing part 112A2-2 determines whether the recognition flag 112A3-2 is set to ON. If the first setting flag 111A1 is not set to ON (NO in OP41), the information processing apparatus 100 terminates the communication process with the partner terminal 400 or the partner terminal 400A.

If the recognition flag 112A3-2 is set to ON (YES in OP42), in OP43, the TCP response processor 112A2-2A creates a RESET packet. If the recognition flag 112A3-2 is not set to ON (NO in OP42), the information processing apparatus 100 terminates the communication process with the partner terminal 400 or the partner terminal 400A.

After creating the RESET packet in OP43, in OP44, the TCP response processor 112A2-2A transmits the RESET packet to the partner terminal 400 or the partner terminal 400A. Then, the information processing apparatus 100 terminates the communication process with the partner terminal 400 or the partner terminal 400A.

Referring to FIG. 9, in OP51, the socket processing part 112A2-2 determines whether the first setting flag 111A1 is set to ON. If the first setting flag 111A1 is set to ON (YES in OP51), in OP52, the socket processing part 112A2-2 determines whether the recognition flag 112A3-2 is set to ON. If the first setting flag 111A1 is not set to ON (NO in OP51), the information processing apparatus 100 terminates the communication process with the partner terminal 400 or the partner terminal 400A.

If the recognition flag 112A3-2 is set to ON (YES in OP52), in OP53, the UDP response processor 112A2-2B creates an unreachable ICMP packet. If the recognition flag 112A3-2 is not set to ON (NO in OP52), the information processing apparatus 100 terminates the communication process with the partner terminal 400 or the partner terminal 400A.

After creating the unreachable ICMP packet in OP53, in OP54, the UDP response processor 112A2-2B transmits the unreachable ICMP packet to the partner terminal 400 or the partner terminal 400A. Then, the information processing apparatus 100 terminates the communication process with the partner terminal 400 or the partner terminal 400A.

Referring to FIG. 10, in OP61, the socket processing part 112A2-2 determines whether the first setting flag 111A1 is set to ON. If the first setting flag 111A1 is set to ON (YES in OP61), in OP62, the socket processing part 112A2-2 determines whether the recognition flag 112A3-2 is set to ON. If the first setting flag 111A1 is not set to ON (NO in OP61), the information processing apparatus 100 terminates the communication process with the partner terminal 400 or the partner terminal 400A.

If the recognition flag 112A3-2 is set to ON (YES in OP62), in OP63, the ICMP response processor 112A2-2C creates an unreachable ICMP packet. If the recognition flag 112A3-2 is not set to ON (NO in OP62), the information processing apparatus 100 terminates the communication process with the partner terminal 400 or the partner terminal 400A.

After creating the unreachable ICMP packet in OP63, in OP64, the ICMP response processor 112A2-2C transmits the unreachable ICMP packet to the partner terminal 400 or the partner terminal 400A. Then, the information processing apparatus 100 terminates the communication process with the partner terminal 400 or the partner terminal 400A.

According to the disclosed technology, even if the OS 111 is fails, it is possible to directly transmit the system down information about the OS 111 in the information processing apparatus 100 to the partner terminal 400 or the partner terminal 400A, which is another information processing apparatus, by operating the kernel 112. Accordingly, the partner terminal 400 or the partner terminal 400A is capable of detecting the system down information about the OS 111 in the information processing apparatus 100 without delay. In addition, since the kernel 112 transmits the packet including the system down information corresponding to the Internet protocol of the destination, the partner terminal 400 or the partner terminal 400A is capable of recognizing the system down of the information processing apparatus 100 without adding dedicated hardware and performing version-up of the OS 111.

All examples and conditional language recited herein are intended for pedagogical purposes to aid the reader in understanding the embodiment and the concepts contributed by the inventor to furthering the art, and are to be construed as being without limitation to such specifically recited examples and conditions, nor does the organization of such examples in the specification relate to a illustrating of the superiority and inferiority of the embodiment. Although the embodiments of the present inventions have been described in detail, it should be understood that the various changes, substitutions, and alterations could be made hereto without departing from the spirit and scope of the invention.

What is claimed is:

1. A method for controlling an information processing apparatus including a processor which operates an operating system and a kernel which is operated independently of the operating system, and a network interface through which the information processing apparatus is connectable to an other information processing apparatus, the method comprising:
notifying, by the operating system, the kernel of system down information about the operating system;
determining, by the kernel, a kind of an Internet protocol included in a packet received from the other information processing apparatus connected through the network interface;
creating, by the kernel, a packet for notifying of the system down in accordance with the determined kind of the Internet protocol; and
transmitting, by the kernel, the created packet to the other information processing apparatus via the network interface.

2. The method according to claim 1, wherein
transmitting of the created packet to the other information processing apparatus via the network interface is performed when the system down information is notified from the operating system to the kernel or when a packet is received from the other information processing apparatus via the network interface.

3. The method according to claim 1, further comprising:
setting information indicating an operation status of the operating system to a state indicating that the system down information is notified upon reception of the system down information from the operating system by the kernel.

4. The method according to claim 1, wherein
the system down information is memory dump information generated by the operating system.

5. The method according to claim 1, wherein
the kind of the Internet protocol is Transmission Control Protocol (TCP), User Datagram Protocol (UDP), or Internet Control Message Protocol (ICMP).

6. An information processing apparatus comprising:
a processor which operates an operating system and a kernel which is operated independently of the operating system;
a memory accessible from the processor; and
a network interface through which the information processing apparatus is connectable to an other information processing apparatus, wherein
the processor
notifies the kernel of system down information about the operating system stored in the memory from the operating system;
determines a kind of an Internet protocol included in a packet received from the other information processing apparatus connected through the network interface;
creates a packet including the system down information in accordance with the determined kind of the Internet protocol; and
transmits the created packet to the other information processing apparatus via the network interface.

7. The information processing apparatus according to claim 6, wherein
the processor transmits the created packet to the other information processing apparatus via the network interface upon reception of a packet from the other information processing apparatus via the network interface.

8. The information processing apparatus according to claim 6, wherein
the processor sets information indicating an operation status of the operating system to a state indicating that the system down information is notified upon reception of the system down information from the operating system.

9. A computer-readable, non-transitory medium storing a program that causes a computer including a processor which operates an operating system and a kernel which is operated independently of operating the operating system to execute a process, the process comprising:
notifying, by the operating system, the kernel of system down information about the operating system;
determining, by the kernel, a kind of an Internet protocol included in a packet received from the other information processing apparatus;
creating, by the kernel, a packet used for the notification of the system down in accordance with the determined kind of the Internet protocol; and
transmitting, by the kernel, the created packet to the other information processing apparatus.

10. The computer-readable, non-transitory medium according to claim 9, wherein
a transmission of the created packet to the other information processing apparatus is performed when the system down information is notified from the operating system to the kernel or when the packet is received from the other information processing apparatus.

11. The computer-readable, non-transitory medium according to claim 9, wherein the process further comprising:
setting information indicating an operation status of the operating system to a state indicating that the system down information is notified upon reception of the system down information from the operating system by the kernel.
